(19) United States
(12) Patent Application Publication
(10) Pub. No.: US 2005/0223606 A1
(43) Pub. Date: Oct. 13, 2005

(54) Cards that facilitate timely and consistent repositioning of bedridden patients

(76) Inventor: Karen U. Paradee, Virginia Beach, VA (US)

Correspondence Address: Needham James Boddie, II;Myers Bigel Sibley & Sajovec, P.A., P.O. Box 37428, Raleigh, NC, 27627, US

(21) Appl. No.: 10/820,187

(22) Filed: Apr. 7, 2004

(51) Int. Cl. G09F 1/00

(52) U.S. Cl. 40/124.01

(57) ABSTRACT

Portable cards that facilitate timely and consistent repositioning of bedridden patients include a base having a generally rigid, rectangular configuration with first and second planar surfaces. Indicia is provided on the first planar surface in a table of two columns and twelve rows. The first column includes sequential two-hour time segments of a twenty-four hour day and the second column includes patient positions. Accordingly, each row in the table includes a time segment and a respective patient position. Each patient position indicates orientation of a patient relative to a room in which the patient is located.

### FIELD OF THE INVENTION

The present invention relates generally to healthcare and, more particularly, to healthcare for bedridden patients.

### BACKGROUND OF THE INVENTION

Pressure ulcers, referred to as bedsores, are a common problem among people who are paralyzed, in a coma, or chronically bedridden. Generally, bedsores occur over the bony protuberances of the body (i.e., areas where the skin is compressed between bone and a hard surface such as a chair or mattress) when a patient remains in one position for an extended period of time, because pressure at these locations can increase to the point where the flow of blood becomes obstructed. Accordingly, to prevent bedsores, it is necessary to reposition bedridden patients according to a schedule.

Conventional medical practice is to reposition a bedridden patient every two hours, rotating the patient from lying on the spine to lying on either the left side or the right side. To accomplish the two-hour repositioning of patients, health care providers are required to keep track of the time that a patient is in the current position and to ensure that the patient is turned to a new position. Unfortunately, it can become difficult to follow a schedule with a large number of patients in a facility. In addition, multiple changes in personnel, that typically occurs during a twenty-four hour period, can lead to inconsistency in turning patients.

U.S. Pat. No. 6,031,791 to Thoni describes a clock that incorporates coding and a legend for monitoring and indicating a periodic event, such as when a bed bound patient needs to be turned or repositioned. The clock includes a face having at least one set of indicia positioned radially about the face for indicating the hours of a day. An hour hand and a minute hand are attached to the face of the clock at a center point thereof, and extend a length therefrom sufficient to indicate the time of day.

There is a need in the art for improved and inexpensive methods of accurately and consistently insuring that bedridden patients are repositioned every two hours.

### SUMMARY OF THE INVENTION

In view of the above discussion, portable cards that facilitate timely and consistent repositioning of bedridden patients are provided. According to an embodiment of the present invention, a card includes a base having a generally rigid configuration with first and second planar surfaces. Indicia is provided on the first planar surface in a table of two columns and twelve rows. The first column of indicia includes sequential two-hour time segments of a twenty-four hour day and the second column of indicia includes patient positions. Accordingly, each row in the table includes a time segment and a respective patient position. Each patient position indicates orientation of a patient relative to a room in which the patient is located.

Cards according to embodiments of the present invention can facilitate consistent and timely positioning of bedridden patients. Using the present invention, a health care provider will know quickly and easily whether patients have been repositioned timely and accurately by simply referring to the card and to the position of a patient. Moreover, no knowledge of previous patient positions is required.

Because of their size and configuration, portable cards according to embodiments of the present invention can be handheld, can be worn under a name badge of a healthcare provider, and can be attached to various other articles.

Cards according to embodiments of the present invention can allow healthcare providers (e.g., nurses, etc.) to assist one another during patient turning times without uncertainty and without having to interrupt others. Cards according to embodiments of the present invention make it easy for healthcare providers to recognize which patients require turning and where others “left off” in turning patients.

Standardizing turning times facilitates better sleep for patients. Moreover, medicine and other treatments can be administered during standard turning times to reduce unnecessary waking of patients. This can reduce patient sleeplessness and/or anxiety. Also, standardized times for turning can help scheduling meals, activities and visitors throughout the day. In addition, if a patient is difficult to move or to communicate with, turning time is an excellent time for physical therapy, speech therapy, etc., since a caregiver who knows the patient will be nearby at that time.

### BRIEF DESCRIPTION OF THE DRAWINGS

FIGS. 1A-1B are respective plan views of the first and second planar surfaces of a card that facilitates timely and consistent repositioning of bedridden patients, according to embodiments of the present invention.

FIG. 2 is a plan view of a card that facilitates timely and consistent repositioning of bedridden patients, according to another embodiment of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines and elements may be exaggerated for clarity. It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. All publications, patent applications, patents, and other references mentioned herein are incorporated by reference in their entirety.

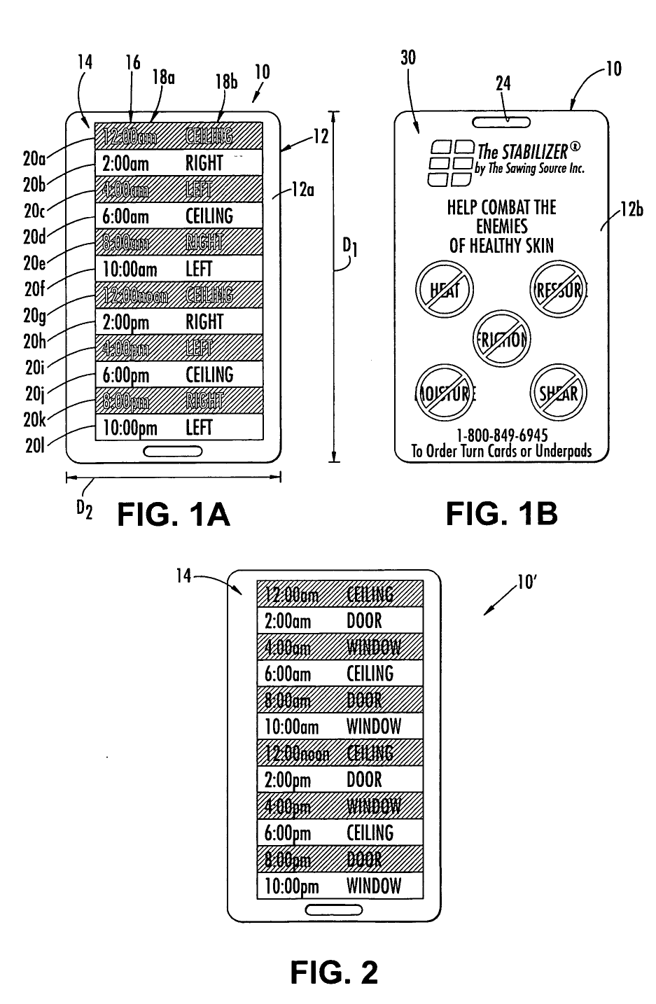

Referring now to FIGS. 1A-1B, a card 10 that facilitates timely and consistent repositioning of bedridden patients, according to embodiments of the present invention, is illustrated. The illustrated card 10 includes a base 12 having a generally rigid, rectangular configuration with first and second planar surfaces 12a, 12b. Indicia, generally referred to as 14, is arranged on the first planar surface 12a in a table 16 of two columns 18a, 18b and twelve rows 20a-201. The first column 18a includes sequential two-hour time segments of a twenty-four hour day and the second column 18b includes patient position information. Accordingly, each row 20a-201 in the table 16 includes a time segment and a respective patient position.

The two-hour time segments described herein are intended to be representative only and are not intended to be limiting. Thus, cards according to embodiments of the present invention may include time segments having any number of hours (or other time periods) of the day and may be organized in various ways. Although illustrated in even hour time segments, it is understood that odd hour time segments (e.g., 1:00AM; 3:00AM; 5:00AM; etc.) may also be utilized according to embodiments of the present invention. Moreover, the arrangement of the indicia 14 within the table 16 is not intended to be limiting. The columns and rows may be arranged in various ways without limitation.

The illustrated card has a generally rectangular configuration with dimensions and thickness similar to that of a conventional credit card. However, embodiments of the present invention are not limited to this illustrated configuration. The card 10 can have virtually any configuration and size desirable. For example, for the illustrated rectangular configuration, the card 10 may have a lengthwise dimension D₁ of between about one inch and about twenty inches and a widthwise dimension D₂ of between about one inch and about twenty inches. Moreover, card 10 may have virtually any geometric shape.

The illustrated card 10 also includes an aperture 24 formed through the base 12 that is configured for attachment of the card 10 to another object, such as a name badge, key ring, clip, strap, etc. Embodiments of the present invention do not require an aperture 24, however. Moreover, additional apertures and apertures having various configurations may be utilized in accordance with other embodiments of the present invention. In the illustrated embodiment, the position of the aperture 24 is at the bottom of the base 12 such that a user wearing the card 10 (e.g., attached to a name tag or badge) can easily turn the card upwardly and read the card 10.

The card base 12 may be formed from various materials. For example, the base 12 may be formed from paper stock material and the indicia 14 may be printed on the paper stock material. A clear plastic film may be laminated to the base 12 over the indicia to provide a glossy, durable finish that is tear resistant and impervious to moisture. According to other embodiments, the base 12 may be formed from polymeric material, from metallic material, and/or combinations thereof.

It will be understood by those skilled in the art that the term “paper”, for purposes of the present application, means any cellulosic or non-cellulosic fibrous material prepared from fibers of wood, cotton, a synthetic material, or combinations thereof as is well known in the paper making art. Exemplary plastic films include, but are not limited to polyester, polyvinyl chloride, polyacrylate, styrene acrylate, and polyethylene terephthalate (e.g., Mylar available from E.I. DuPont de Nemours & Co.).

In the illustrated embodiment of FIG. 1A, each patient position (column 18b) indicates orientation of a patient relative to a room in which the patient is located. For example, at 12:00 am, a patient is to be positioned such that the patient is facing the ceiling of the room (i.e., the patient is positioned on his/her back). At 2:00 am, the patient is to be repositioned so as to be facing to the right (i.e., the patient is positioned on his/her right side). At 4:00 am, the patient is to be repositioned so as to be facing to the left (i.e., the patient is positioned on his/her left side). At 6:00 am, the above-described three-position rotation begins again and is continued throughout a twenty-four hour day.

According to embodiments of the present invention, the second planar surface 12b includes promotional indicia 30. However, the second planar surface 12b may be blank or may have other indicia thereon according to other embodiments of the present invention.

In the illustrated embodiment of FIG. 1A, the rows (20a-20l) in the table 16 are color coded to facilitate easy reading. However, embodiments of the present invention do not require the rows to be color coded.

Referring to FIG. 2, a card 10′, according to another embodiment of the present invention, includes patient position information that indicates orientation of a patient relative to a ceiling, door and window in a room in which the patient is located. For example, at 12:00 am, a patient is to be positioned such that the patient is facing the ceiling of the room (i.e., the patient is positioned on his/her back). At 2:00 am, the patient is to be repositioned so as to be facing a door in the room (i.e., the patient is positioned on his/her side so as to be facing the door). At 4:00 am, the patient is to be repositioned so as to be facing a window in the room (i.e., the patient is positioned on his/her other side so as to be facing the window). At 6:00 am, the above-described three-position rotation begins again and is continued throughout a twenty-four hour day.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A portable card that facilitates timely and consistent repositioning of bedridden patients, comprising:
a base having a planar surface; and
indicia on the planar surface that indicates a plurality of time segments of a day and a respective patient position for each time segment.

2. The card of claim 1, wherein the time segments are two-hour time segments for a twenty-four hour day.

3. The card of claim 1, wherein the indicia is arranged in two adjacent columns, wherein a first column includes sequential time segments of a day and wherein a second column includes patient positions.

4. The card of claim 1, wherein patient position indicia indicates orientation of a patient relative to a room in which the patient is located.

5. The card of claim 3, wherein patient position indicia indicates orientation of a patient relative to a ceiling within the room.

6. The card of claim 3, wherein patient position indicia indicates orientation of a patient relative to a ceiling and door within the room.

7. The card of claim 3, wherein patient position indicia indicates orientation of a patient relative to a ceiling, door and window within the room.

8. The card of claim 1, wherein the time segment and patient position indicia are color coded.

9. The card of claim 1, further comprising an aperture formed through the base that is configured for attachment of the card to another article.

10. The card of claim 1, wherein the base has a generally rigid, rectangular configuration.

11. The card of claim 10, wherein the base has a lengthwise dimension of between about one inch and about twenty inches and a widthwise dimension of between about one inch and about twenty inches.

12. The card of claim 10, wherein the base comprises a base of paper stock material having the indicia printed thereon, and a clear plastic film laminated to the base of paper stock material over the indicia.

13. The card of claim 1, wherein the base comprises a second planar surface and wherein promotional indicia is printed on the second planar surface.

14. A portable card that facilitates timely and consistent repositioning of bedridden patients, comprising:
a base having a planar surface; and
indicia on the planar surface arranged in a table of two columns and twelve rows, wherein a first column includes sequential two-hour time segments of a twenty-four hour day and wherein a second column includes patient positions such that each row in the table includes a time segment and a respective patient position.

15. The card of claim 14, wherein each patient position indicates orientation of a patient relative to a room in which the patient is located.

16. The card of claim 15, wherein each patient position indicates orientation of a patient relative to a ceiling within the room.

17. The card of claim 15, wherein each patient position indicates orientation of a patient relative to a ceiling and door within the room.

18. The card of claim 15, wherein each patient position indicates orientation of a patient relative to a ceiling, door and window within the room.

19. The card of claim 14, wherein the rows in the table are color coded.

20. The card of claim 14, further comprising an aperture formed through the base that is configured for attachment of the card on an article.

21. The card of claim 14, wherein the base has a generally rigid, rectangular configuration.

22. The card of claim 21, wherein the base has a lengthwise dimension of between about one inch and about twenty inches and a widthwise dimension of between about one inch and about twenty inches.

23. The card of claim 21, wherein the base comprises a base of paper stock material having the indicia printed thereon, and a clear plastic film laminated to the base of paper stock material over the indicia.

24. The card of claim 14, wherein the base comprises a second planar surface and wherein promotional indicia is printed on the second planar surface.

25. A portable card that facilitates timely and consistent repositioning of bedridden patients, comprising:
a base having a generally rigid, rectangular configuration with first and second planar surfaces; and
indicia on the first planar surface arranged in a table of two columns and twelve rows, wherein a first column includes sequential two-hour time segments of a twenty-four hour day and wherein a second column includes patient positions such that each row in the table includes a time segment and a respective patient position, wherein each patient position indicates orientation of a patient relative to a room in which the patient is located.

26. The card of claim 25, wherein each patient position indicates orientation of a patient relative to a ceiling within the room.

27. The card of claim 25, wherein each patient position indicates orientation of a patient relative to a ceiling and door within the room.

28. The card of claim 25, wherein each patient position indicates orientation of a patient relative to a ceiling, door and window within the room.

29. The card of claim 25, wherein the rows in the table are color coded.

30. The card of claim 25, further comprising an aperture formed through the base that is configured for attachment of the card on an article.

31. The card of claim 25, wherein the base has a lengthwise dimension of between about one inch and about twenty inches and a widthwise dimension of between about one inch and about twenty inches.

32. The card of claim 25, wherein the base comprises a base of paper stock material having the indicia printed thereon, and a clear plastic film laminated to the base of paper stock material over the indicia.

33. The card of claim 25, wherein the base comprises a second planar surface and wherein promotional indicia is printed on the second planar surface.
